(19) United States
(12) Patent Application Publication
(10) Pub. No.: US 2003/0016275 A1
(43) Pub. Date: Jan. 23, 2003

(54) Continuous ink jet printhead with improved drop formation and apparatus using same

(75) Inventors: David L. Jeanmaire, Brockport, NY (US); James M. Chwalek, Pittsford, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 09/910,097

(22) Filed: Jul. 20, 2001

(51) Int. Cl. B41J 2/07

(52) U.S. Cl. 347/74

(57) ABSTRACT

An ink jet printer includes a print head having a nozzle from which a stream of ink droplets is emitted. A mechanism is adapted to adjust a characteristic of the emitted ink droplets such that selected pairs of droplets emitted from the nozzle coalesce to form larger droplets while other ones of droplets emitted from the nozzle do not coalesce. A droplet deflector imposes a force on the droplets at an angle greater than zero with respect to the stream of ink droplets. The droplet deflector is adapted to interact with the stream of ink droplets to thereby separate non-coalesced ink droplets from coalesced ink droplets.

### CROSS REFERENCE TO RELATED APPLICATIONS

Reference is made to commonly assigned, co-pending U.S. patent application Ser. No. 09/750,946, filed in the names of David L. Jeanmaire et al. on Dec. 28, 2000; Ser. No. 09/861,692 filed in the name of David L. Jeanmaire on May 21, 2001; and Ser. No. 09/892,831 filed in the name of David L. Jeanmaire on Jun. 27, 2001.

### FIELD OF THE INVENTION

This invention relates generally to the field of digitally controlled printing devices, and in particular to continuous inkjet printers wherein a liquid ink stream breaks into droplets, some of which are selectively deflected.

### BACKGROUND OF THE INVENTION

Traditionally, digitally controlled color ink jet printing capability is accomplished by one of two technologies. The first technology, commonly referred to as “drop-on-demand” ink jet printing, typically provides ink droplets for impact upon a recording surface using a pressurization actuator (thermal, piezoelectric, etc.). Selective activation of the actuator causes the formation and ejection of a flying ink droplet that crosses the space between the print head and the print media and strikes the print media. The formation of printed images is achieved by controlling the individual formation of ink droplets, as is required to create the desired image. Typically, a slight negative pressure within each channel keeps the ink from inadvertently escaping through the nozzle, and also forms a slightly concave meniscus at the nozzle, thus helping to keep the nozzle clean.

With thermal actuators, a heater, located at a convenient location, heats the ink causing a quantity of ink to phase change into a gaseous steam bubble. This increases the internal ink pressure sufficiently for an ink droplet to be expelled. For example, in a bubble jet printer, ink in a channel of a printhead is heated creating a bubble that increases internal pressure ejecting an ink droplet out of a nozzle of the printhead. The bubble then collapses as the heating element cools, and the resulting vacuum draws fluid from a reservoir to replace ink that was ejected from the nozzle. The bubble then collapses as the heating element cools, and the resulting vacuum draws fluid from a reservoir to replace ink that was ejected from the nozzle.

Piezoelectric actuators, such as that disclosed in U.S. Pat. No. 5,224,843, issued to vanLintel on Jul. 6, 1993, have a piezoelectric crystal in an ink fluid channel that flexes when an electric current flows through it forcing an ink droplet out of a nozzle. The most commonly produced piezoelectric materials are ceramics, such as lead zirconate titanate, barium titanate, lead titanate, and lead metaniobate.

In U.S. Pat. No. 4,914,522, which issued to Duffield et al. on Apr. 3, 1990, a drop-on-demand ink jet printer utilizes air pressure to produce a desired color density in a printed image. Ink in a reservoir travels through a conduit and forms a meniscus at an end of an ink nozzle. An air nozzle, positioned so that a stream of air flows across the meniscus at the end of the nozzle, causes the ink to be extracted from the nozzle and atomized into a fine spray. The stream of air is applied for controllable time periods at a constant pressure through a conduit to a control valve. The ink dot size on the image remains constant while the desired color density of the ink dot is varied depending on the pulse width of the air stream.

The second technology, commonly referred to as “continuous stream” or “continuous” inkjet printing, uses a pressurized ink source that produces a continuous stream of ink droplets. Conventional continuous inkjet printers utilize electrostatic charging devices that are placed close to the point where a filament of ink breaks into individual ink droplets. The ink droplets are electrically charged and then directed to an appropriate location by deflection electrodes. When no print is desired, the ink droplets are directed into an ink-capturing mechanism (often referred to as catcher, interceptor, or gutter). When print is desired, the ink droplets are directed to strike a print media.

Typically, continuous ink jet printing devices are faster than dropon-demand devices and produce higher quality printed images and graphics. However, each color printed requires an individual droplet formation, deflection, and capturing system.

U.S. Pat. No. 1,941,001, issued to Hansell on Dec. 26, 1933, and U.S. Pat. No. 3,373,437 issued to Sweet et al. on Mar. 12, 1968, each disclose an array of continuous ink jet nozzles wherein ink droplets to be printed are selectively charged and deflected towards the recording medium. This technique is known as binary deflection continuous inkjet.

U.S. Pat. No. 3,416,153, issued to Hertz et al. on Oct. 6, 1963, discloses a method of achieving variable optical density of printed spots in continuous ink jet printing using the electrostatic dispersion of a charged droplet stream to modulate the number of droplets which pass through a small aperture.

U.S. Pat. No. 3,878,519, issued to Eaton on Apr. 15, 1975, discloses a method and apparatus for synchronizing droplet formation in a liquid stream using electrostatic deflection by a charging tunnel and deflection plates.

U.S. Pat. No. 4,346,387, issued to Hertz on Aug. 24, 1982, discloses a method and apparatus for controlling the electric charge on droplets formed by the breaking up of a pressurized liquid stream at a droplet formation point located within the electric field having an electric potential gradient. Droplet formation is effected at a point in the field corresponding to the desired predetermined charge to be placed on the droplets at the point of their formation. In addition to charging tunnels, deflection plates are used to actually deflect droplets. 22

U.S. Pat. No. 4,638,382, issued to Drake et al. on Jan. 20, 1987, discloses a continuous ink jet printhead that utilizes constant thermal pulses to agitate ink streams admitted through a plurality of nozzles in order to break up the ink streams into droplets at a fixed distance from the nozzles. At this point, the droplets are individually charged by a charging electrode and then deflected using deflection plates positioned the droplet path.

As conventional continuous ink jet printers utilize electrostatic charging devices and deflector plates, they require many components and large spatial volumes in which to operate. This results in continuous ink jet printheads and printers that are complicated, have high energy requirements, are difficult to manufacture, and are difficult to control.

U.S. Pat. No. 3,709,432, issued to Robertson on Jan. 9, 1973, discloses a method and apparatus for stimulating a filament of working fluid causing the working fluid to break up into uniformly spaced ink droplets through the use of transducers. The lengths of the filaments before they break up into ink droplets are regulated by controlling the stimulation energy supplied to the transducers, with high amplitude stimulation resulting in short filaments and low amplitude stimulations resulting in longer filaments. A flow of air is generated across the paths of the fluid at a point intermediate to the ends of the long and short filaments. The air flow affects the trajectories of the filaments before they break up into droplets more than it affects the trajectories of the ink droplets themselves. By controlling the lengths of the filaments, the trajectories of the ink droplets can be controlled, or switched from one path to another. As such, some ink droplets may be directed into a catcher while allowing other ink droplets to be applied to a receiving member.

While this method does not rely on electrostatic means to affect the trajectory of droplets, it does rely on the precise control of the break up points of the filaments and the placement of the air flow intermediate to these break up points. Such a system is difficult to control and to manufacture. Furthermore, the physical separation or amount of discrimination between the two droplet paths is small, further adding to the difficulty of control and manufacture.

U.S. Pat. No. 4,190,844, issued to Taylor on Feb. 26, 1980, discloses a continuous ink jet printer having a first pneumatic deflector for deflecting non-printed ink droplets to a catcher and a second pneumatic deflector for oscillating printed ink droplets. A print head supplies a filament of working fluid that breaks into individual ink droplets. The ink droplets are then selectively deflected by a first pneumatic deflector, a second pneumatic deflector, or both. The first pneumatic deflector is an “ON/OFF” type having a diaphragm that either opens or closes a nozzle depending on one of two distinct electrical signals received from a central control unit. This determines whether the ink droplet is to be printed or non-printed. The second pneumatic deflector is a continuous type having a diaphragm that varies the amount that a nozzle is open, depending on a varying electrical signal received the central control unit. This oscillates printed ink droplets so that characters may be printed one character at a time. If only the first pneumatic deflector is used, characters are created one line at a time, being built up by repeated traverses of the print head.

While this method does not rely on electrostatic means to affect the trajectory of droplets, it does rely on the precise control and timing of the first (“ON/OFF”) pneumatic deflector to create printed and non-printed ink droplets. Such a system is difficult to manufacture and accurately control, resulting in at least the ink droplet build up discussed above. Furthermore, the physical separation or amount of discrimination between the two droplet paths is erratic due to the precise timing requirements, increasing the difficulty of controlling printed and non-printed ink droplets and resulting in poor ink droplet trajectory control.

Additionally, using two pneumatic deflectors complicates construction of the print head and requires more components. The additional components and complicated structure require large spatial volumes between the print head and the media, increasing the ink droplet trajectory distance. Increasing the distance of the droplet trajectory decreases droplet placement accuracy and affects the print image quality. Again, there is a need to minimize the distance that the droplet must travel before striking the print media in order to insure high quality images. Pneumatic operation requiring the air flows to be turned on and off is necessarily slow, in that an inordinate amount of time is needed to perform the mechanical actuation as well as time associated with the settling any transients in the air flow.

U.S. Pat. No. 6,079,821, issued to Chwalek et al. on Jun. 27, 2000, discloses a continuous inkjet printer that uses actuation of asymmetric heaters to create individual ink droplets from a filament of working fluid and to deflect those ink droplets. A print head includes a pressurized ink source and an asymmetric heater operable to form printed ink droplets and non-printed ink droplets. Printed ink droplets flow along a printed ink droplet path ultimately striking a receiving medium, while non-printed ink droplets flow along a non-printed ink droplet path ultimately striking a catcher surface. Non-printed ink droplets are recycled or disposed of through an ink removal channel formed in the catcher. While the ink jet printer disclosed in Chwalek et al. works extremely well for its intended purpose, using a heater to create and to deflect ink droplets increases the energy and power requirements of this device.

The use of an air stream has been proposed to separate ink drops of a plurality of volumes into spatially differing trajectories. Non-imaging droplets, having one range of volumes, are not permitted to reach the image receiver, while imaging droplets having a significantly different range of volumes are permitted to make recording marks on the receiver. While print heads employing such disclosures work well, there is a certain determinable distance from the printhead that is required for drop formation to be complete. In these printheads, fluid breakup of an ink stream into droplets is caused by temperature changes due to heater activation by electrical pulses. Following the initial fluid breakup, larger drops are created through the coalescence of smaller drops and fluidic strings, and this coalescence distance is a function of fluid and thermal properties (e.g., surface tension, viscosity, thermal conductivity, etc.) as well as the operating conditions such as ink pressure and drop velocity. Generally, the trajectory separation air stream cannot be applied to the droplet stream until the desired drop formation has taken place. Thus, substantial distances for drop formation result in greater distances separating the printhead from the recording media, with the potential for degradation of drop-placement accuracy on the media.

### SUMMARY OF THE INVENTION

It is an object of the present invention to provide an ink jet print head and printer of simple construction having simple control of individual ink droplets with a decreased distance required for drop formation. The amount of physical separation between print head and the recording media can therefore be reduced, while retaining the low energy and power consumption advantage of the printing method described above.

According to a feature of the present invention, an ink jet printer includes a print head having a nozzle from which a stream of ink droplets is emitted. A mechanism is adapted to adjust a characteristic of the emitted ink droplets such that selected pairs of droplets emitted from the nozzle coalesce to form larger droplets while other ones of droplets emitted from the nozzle do not coalesce.

According to a preferred embodiment of the present invention, a droplet deflector imposes a force on the droplets at an angle greater than zero with respect to the stream of ink droplets. The droplet deflector is adapted to interact with the stream of ink droplets to thereby separate non-coalesced ink droplets from coalesced ink droplets.

### BRIEF DESCRIPTION OF THE DRAWINGS

Other features and advantages of the present invention will become apparent from the following description of the preferred embodiments of the invention and the accompanying drawings, wherein:

FIG. 1 is a schematic plan view of a printhead made in accordance with a preferred embodiment of the present invention;

FIG. 2 is a diagram illustrating a frequency control of a heater as disclosed in the prior art;

FIG. 3 shows captured images of jet break-off and drop formation as a result of the applied electrical waveforms of heater activation in accordance the prior art;

FIG. 4 shows a captured image of jet break-off and drop formation, along with schematic views of electrical waveforms of heater activation in accordance with the preferred embodiment of the present invention;

FIG. 5 is a plot of the effect of pre-pulse timing on drop formation in accordance with the preferred embodiment of the present invention;

FIG. 6 is a schematic view of the improvement in drop formation distance for the preferred embodiment of the present invention, relative to the prior art;

FIG. 7 is a schematic view of the jetting of ink from nozzle groups in a printhead made in accordance with the preferred embodiment of the present invention, wherein a force provided by a gas flow separates a plurality of drop volumes into printing and non-printing paths; and

FIG. 8 is an inkjet printing apparatus made in accordance with the preferred embodiment of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

FIG. 1 shows an ink droplet forming mechanism 19 including a print head 17, at least one ink supply 14, and a controller 13. Although ink droplet forming mechanism 19 is illustrated schematically and not to scale, one of ordinary skill in the art will be able to readily determine the specific size and interconnections of the elements of a practical mechanism.

In a preferred embodiment of the present invention, print head 17 is formed from a semiconductor material (such as, for example, silicon) using known semiconductor fabrication techniques. Such known techniques include CMOS circuit fabrication, micro-electro mechanical structure (MEMS) fabrication, etc. However, print head 17 may be formed from any materials using any suitable fabrication techniques.

Nozzles 7 are in fluid communication with ink supply 14 through an ink passage (not shown) formed in print head 17. Print head 17 may incorporate additional ink supplies in the manner of 14 and corresponding nozzles 7 in order to provide color printing using a plurality of ink colors. Single color printing may be accomplished using a single ink supply.

A heater 3 is at least partially formed or positioned on print head 17 around a corresponding nozzle 7. Although heaters 3 may be disposed radially away from an edge of the corresponding nozzle 7, the heaters are preferably disposed close to their corresponding nozzle in a concentric manner. In a preferred embodiment, heaters 3 are formed in a substantially circular or ring shape. However, the heaters may be formed in a partial ring, square, etc. Heaters 3 in a preferred embodiment consist principally of electric resistive heating elements electrically connected to electrical contact pads 11 via conductors 18.

Conductors 18 and electrical contact pads 11 may be at least partially formed or positioned on print head 17 to provide electrical connection between controller 13 and heaters 3. Alternatively, the electrical connection between controller 13 and heaters 3 may be accomplished in any well-known manner. Controller 13 may be a relatively simple device (a power supply for heaters 3, etc.) or a relatively complex device (logic controller, programmable microprocessor, etc.) operable to control many components (heaters 3, ink droplet forming mechanism 19, etc.) in a desired manner.

Printhead 17 is able to create drops having a plurality of volumes. In the preferred implementation of this invention, smaller drops are used for printing, while larger drops are prevented from striking an image receiver. The creation of large ink drops for involves two steps. The first is the activation of heater 3 associated with nozzle 7 with an appropriate waveform to cause a jet of ink fluid to break up into fluidic structures having a plurality of volumes. Secondly, portions of the fluidic structures originating from jet breakup coalesce to form larger drops.

Work in the field using a gas flow drop separation means, focuses on electrical waveforms of heater activation to deliver one ink droplet per nozzle to the recording media during a time interval associated with the printing of a pixel of image data. As a result of heater actuation in accordance with these waveforms, the jet of ink emanating from a nozzle is broken up into droplets, some of which may re-coalesce, forming larger droplets. The coalescence process is integral to drop formation where larger drop sizes are desired, and is essential to obtaining large ratios in drop volumes between non-printing and printing drops, prior to the application of a separation force due to gas flow. Larger volume ratios result in greater discrimination between the printing and non-printing drops.

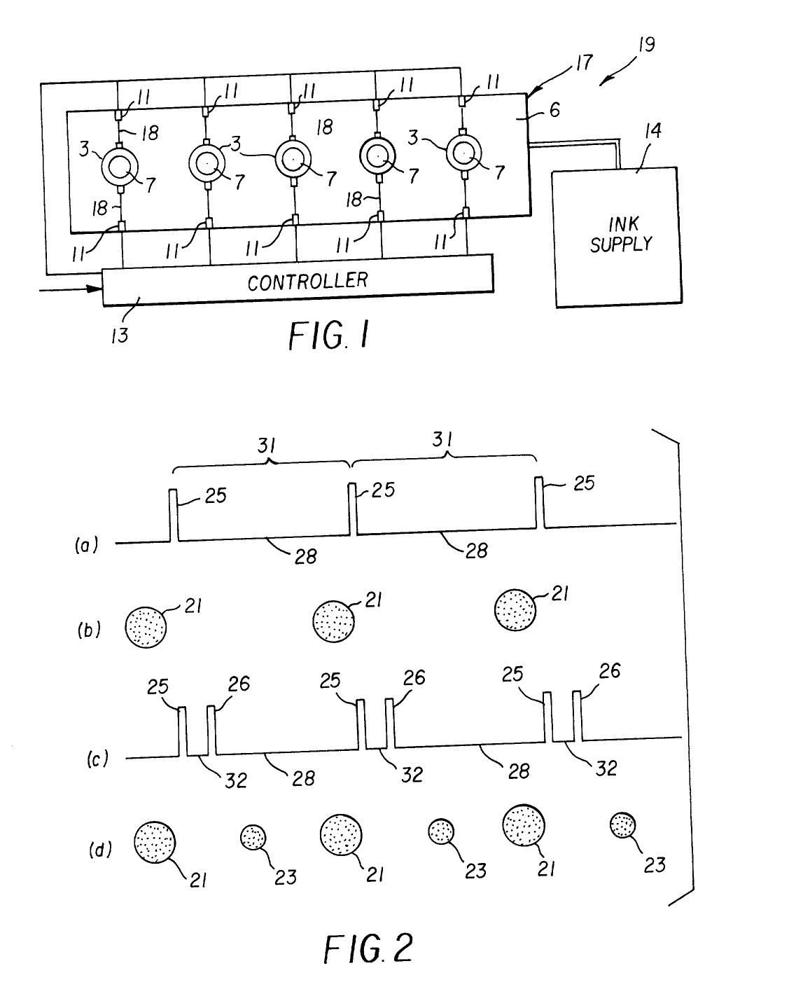

Referring to FIG. 2, an example of the electrical activation waveform provided by controller 13 to heater 3 to create a stream of non-printing drops is shown as curve (a). The time interval 31 associated with one pixel of image data contains one activation pulse 25 at the start of the interval, followed by a delay 28 until the start of the next pixel. In the generation of non-printing drops, it is advantageous for there to be only one large drop created in the interval associated with one pixel of image data 31. Individual ink droplets 21 resulting from the jetting of ink from nozzle 7, in combination with this heater actuation according to curve (a), are shown schematically at (b) at a distance from the printhead where the desired droplet formation is complete.

The complementary (imagewise) electrical waveform of heater activation for the printing of a drop is shown schematically as curve (c), and consists of two heater activation pulses 25 and 26, separated by delay time 32. Delay 32 is chosen to be less than delay 28, preferably less by a factor of 4 or more. The activation of heater 3 according to this waveform, during one pixel interval 31, forms two drops, one smaller printing drop 23 and a larger nonprinting drop 21 as shown schematically at (d).

Selectively, either heater activation waveform curve (a) or curve (c) is issued according to controller 13 according to whether printing or nonprinting drops are required in accordance with image data. While only one printing drop per image pixel time interval 31 is shown here for simplicity of illustration, it must be understood that the same method may be logically extended to give a larger maximum count of printing drops during the image pixel time interval 31.

Referring again to curves (a) and (c) of FIG. 2, electrical pulses 25 and 26 are typically from about 0.1 microseconds to about 10 microseconds in duration and more preferentially about 0.5 microseconds to about 1.5 microseconds. Delay time 32 is typically about 0.5 microseconds to about 20 microseconds, and more preferentially, from about 1 microsecond to about 5 microseconds. Time delay 28 is preferably chosen to be long relative to delay 32, say 20 to 500 microseconds, so that the volume ratio of large printing drops to small non-printing drops will be a factor of four or greater.

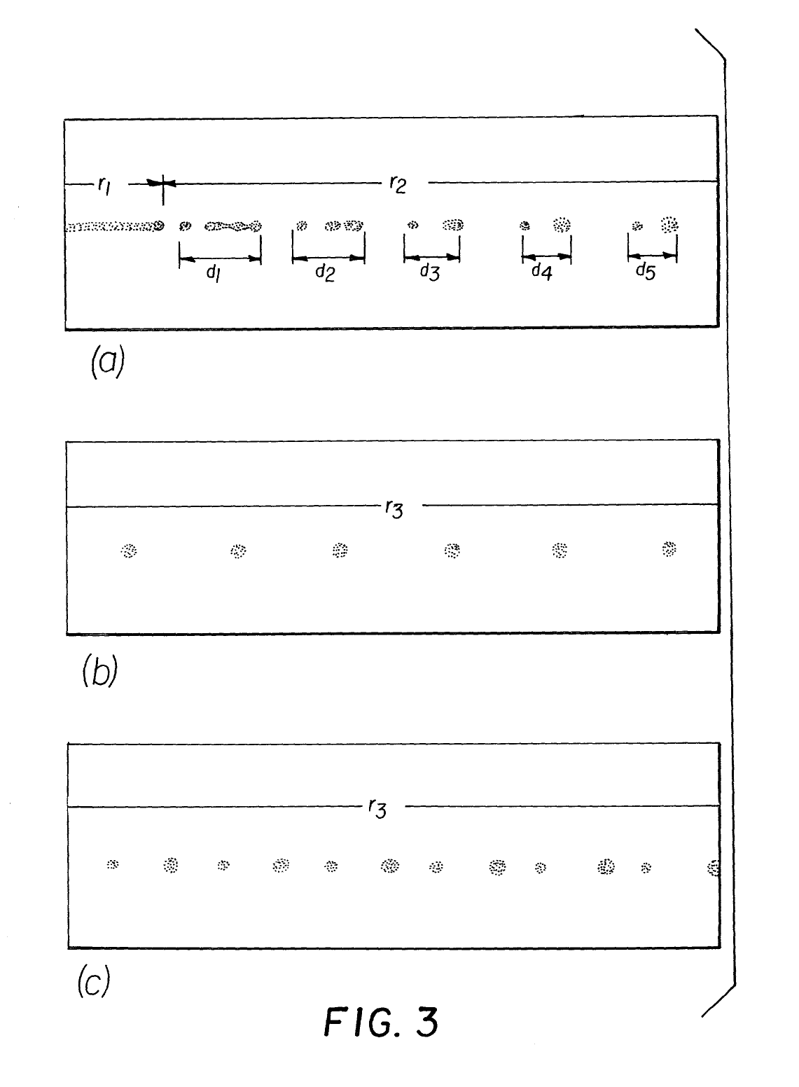

The significance of the coalescence step of printing drop formation, in relation to the current invention, is explained by referring to the reproduction of a photographic image of ajet, captured with stroboscopic illumination, in FIG. 3(a). Heater 3 is activated in accordance with the waveform of FIG. 2's curve (a). A jet of ink fluid moving at 14 m/sec is shown in region r₁. Breakup of the jet occurs approximately 1 mm from the printhead at the left (not shown). Region r₂ consists of groups of droplets which coalesce in flight, the distances d₁, d₂, d₃, d₄ and d₅ showing the progressive merging of the droplets within a group, as they move further away from the printhead. In this example, region r₂ extends a considerable distance beyond the area shown in the image.

FIG. 3(b) is a captured image of the same jet as in FIG. 3(a), however, the distance from the printhead has increased. Droplet coalescence is complete to the point of producing one large drop per image pixel time 31, (20 microseconds in this example). This region is designated as r₃ and follows region r₂. In this region, the captured image is now similar to the desired schematic shown in at (b) in FIG. 2.

Considering now the creation of printing drops, the image of FIG. 3(c) shows the result of the activation of heater 3 with the printing waveform of FIG. 2's curve (c) on the drop formation, wherein one smaller and one larger drop are formed per image pixel time interval 31. This is similar to the drop formation shown schematically at (d) in FIG. 2. The image in FIG. 3(c) is taken at the same distance from the printhead as the image in FIG. 3(b), and is in region r₃.

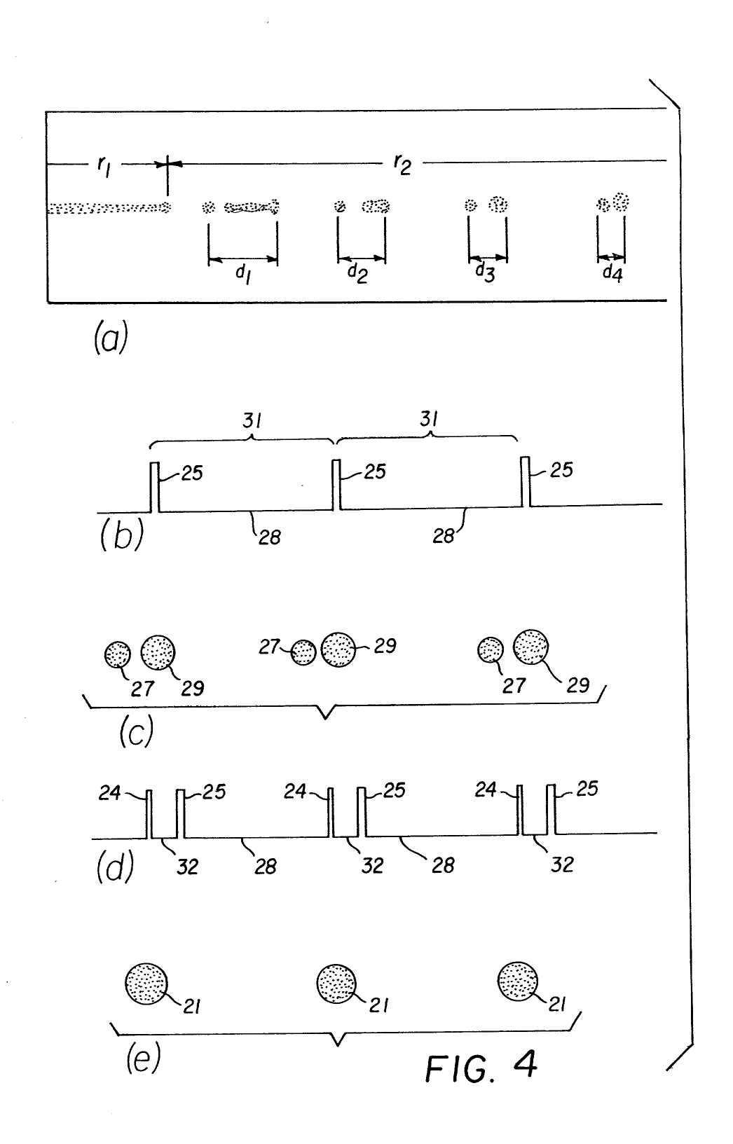

A feature of the present invention involves the extension of the electrical waveforms used for heater 3 activation by the addition of a pre-pulse 24 (shown in FIG. 4(d)) at the start of every pixel time interval 31. The concomitant effect is that the distance for drop coalescence (as designated by the region r₂) is significantly reduced. The previous work is again referred to in FIG. 4(b) in the schematic representation of the waveform for heater 3 activation for the production of non-printing drops. In region r₂, drop coalescence is incomplete, and the majority of the region contains clusters of drops. This is shown schematically in FIG. 4(c), where there is more than one drop per image pixel time 31, as can also be seen in the experimental image of FIG. 3(a) referring to distances d₄ and d₅. Referring to FIG. 4(d), in a preferred embodiment of this invention, pre-pulse 24 is added prior to pulse 25, where pre-pulse 24 causes less energy to be dissipated in heater 3, than does pulse 25. Initial jet breakup is only subtly affected, as can be seen in the image captured in FIG. 4(a) (with pre-pulse) vs. the image in FIG. 3(a) (without pre-pulse 24). Note, however, that by indicated distance d₄ in region r₂ of FIG. 4(a) that the drops have nearly combined as compared to the same region in FIG. 3(a). The facility of the drop coalescence is shown schematically in FIG. 4(e), with the result that the length of region r₂ is significantly reduced. Pre-pulse 24 is applied to the start of both printing and non-printing waveforms.

FIG. 5 contains a plot of data which show that the efficacy of prepulse 24 is strongly dependent upon the time delay 32 which separates the prepulse from pulse 25 as in the waveform of FIG. 4(d). In this example, pre-pulse 24 is 0.2 microsecond, pulse 25 is 1.0 microsecond, and delay 28 is 27 microseconds in duration respectively. With delay 32 at zero, the resulting drop formation in region r₂ substantially resembles that shown schematically in FIG. 4(c). The distance, Q, between drops 27 and 29 is recorded in FIG. 5 as delay 32 is increased. As indicated in the plot, drops 27 and 29 only coalesce when delay 32 is near 1.5 microseconds.

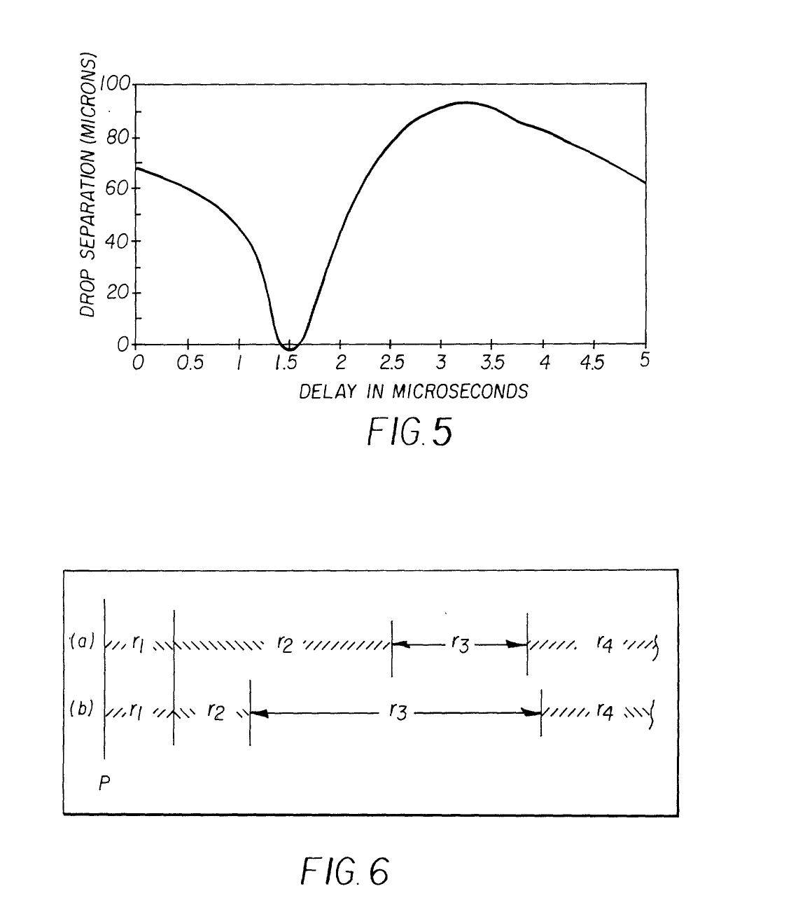

The advantage of this invention in the design and operation of a printing apparatus is reflected in the diagram of FIG. 6. Trace (a) represents the prior art, while trace (b) represents the described improvement regarding the addition of a pre-pulse 24 to heater 3 activation. Both traces (a) and (b) show the relative distances of the regions of drop formation from printhead P. Region r₁ consists of a continuous column of fluid jetting from nozzle 7. Region r₂ represents a drop-formation regime in which droplet coalescence is not yet complete. Region r₃ contains coalesced droplets which have the desired volumes in accordance with printing and non-printing image data. It is in this region (or a portion thereof) where the separation means provided by gas flow is to be applied. In region r₄ coalescence of printing and non-printing drops can occur, for example referring to FIG. 4(d), printing drop 23 may merge with non-printing drop 21. Thus, it is undesirable to apply a separation force that discriminates based upon drop volume in regions other than r₃. In the case of the example discussed previously, for trace (a), the lengths of regions r₁, r₂ and r₃ are 1.0 mm, 3.6 mm, and 2.4 mm respectively. For trace (b), the lengths are 1.0 mm, 1.3 mm and 4.8 mm respectively. Clearly, region r₃ has moved closer to printhead P by 2.3 mm as compared to trace (b). This allows a shorter distance from the printhead to the image receiver, thus resulting in a more accurate placement of ink drops onto the image receiver and consequently improved image quality.

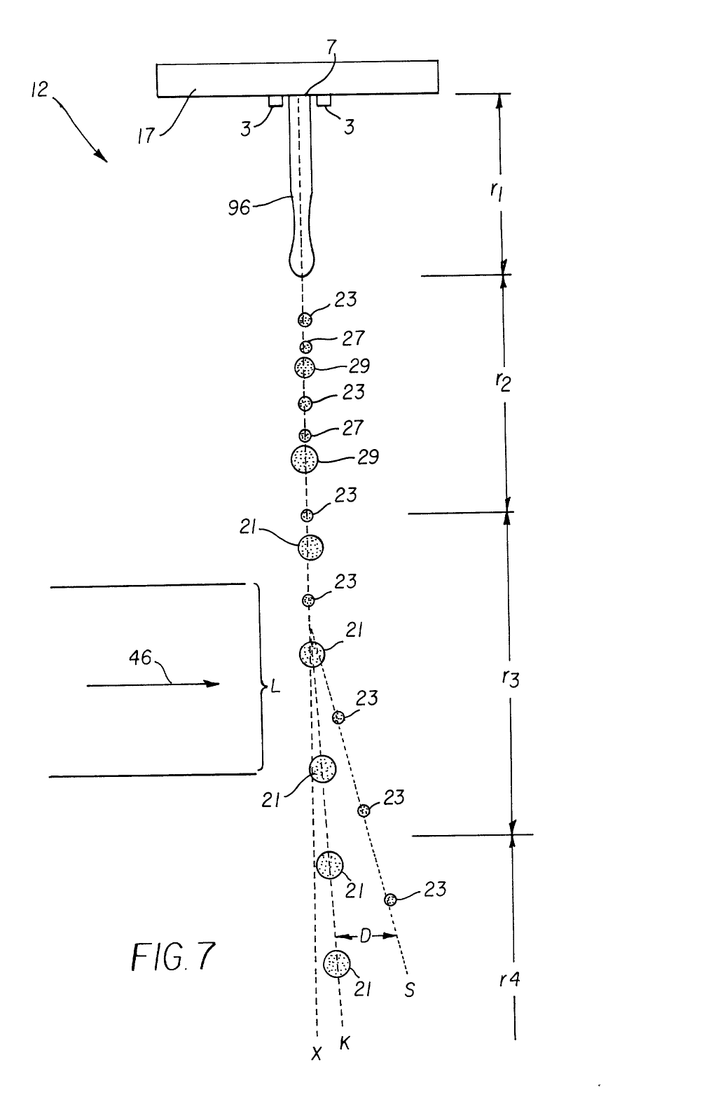

The operation of printhead 17 in a manner such as to provide an image-wise modulation of drop volumes, as described above, is coupled with a discrimination means which separates droplets into printing or non-printing paths according to drop volume. Referring to FIG. 7, ink is ejected through nozzle 7 in printhead 17, creating a filament of working fluid 96 moving substantially perpendicular to printhead 17 along axis X. Heater 3 is selectively activated at various frequencies according to image data, causing filament of working fluid 96 to break up into a stream of individual ink droplets. Coalescence of drops 27 and drops 29 is assumed to occur to form a large, non-printing drop 21. It can be seen that, at the distance from the printhead 17 that the discrimination means is applied, droplets are of two size classes: small, printing drops 23 and large, non-printing drops 21.

In the preferred implementation, the discrimination means is a gas flow perpendicular to axis X, the gas flow producing a force 46 which acts over distance L. Distance L is less than or equal to distance r₃. Large, non-printing drops 21 have a greater mass and more momentum than small volume drops 23. As gas force 46 interacts with the stream of ink droplets, the individual ink droplets separate depending on each droplet's volume and mass. The gas flow can be adjusted to provide sufficient separation D between the path S of small droplets and the path K of large droplets such that small, printing drops 23 strike print media W while large, non-printing drops 21 are captured by a ink guttering structure described below.

A separation angle D between the large, non-printing drops 21 and the small, printing drops 23 will not only depend on their relative size, but also on the velocity, density, and viscosity of the gas flow producing force 46; the velocity and density of the large, non-printing drops 21 and small, printing drops 23; and the interaction distance (shown as L in FIG. 7) over which the large, non-printing drop 21 and the small, printing drops 23 interact with the gas flow. Gases, including air, nitrogen, etc., having different densities and viscosities can also be used with similar results.

Large, printing drops 21 and small, non-printing drops 23 can be of any appropriate relative size. However, the droplet size is primarily determined by ink flow rate through nozzle 7 and the frequency at which heater 3 is cycled. The flow rate is primarily determined by the geometric properties of nozzle 7 such as nozzle diameter and length, pressure applied to the ink, and the fluidic properties of the ink such as ink viscosity, density, and surface tension. Although a wide range of droplet sizes are possible, in the example provided here, for a 10 micron diameter nozzle, large, non-printing drops 21 are 16 picoliters in volume, while small, printing droplets are 4 picoliters in volume.

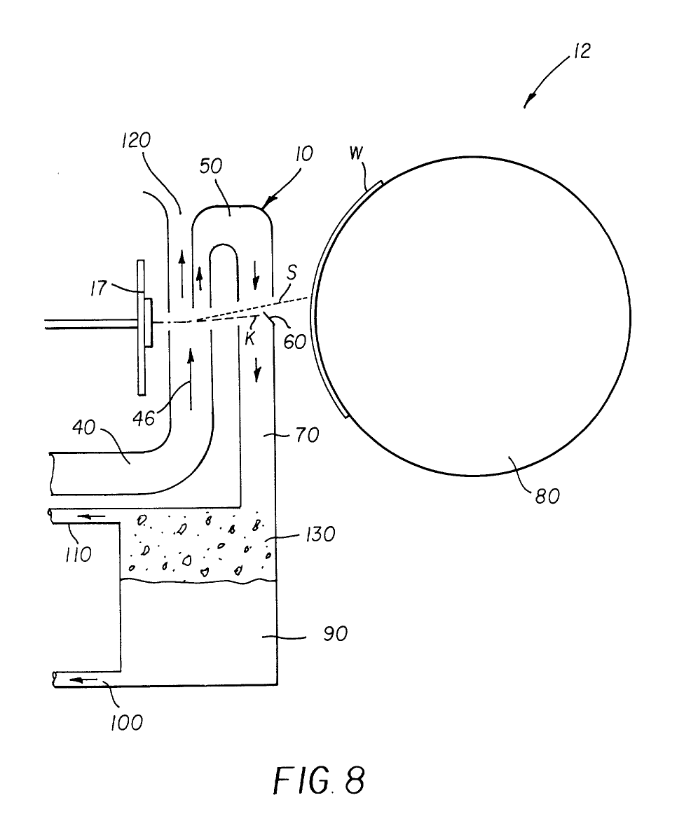

FIG. 8 shows a printing apparatus 12 (typically, an ink jet printer or printhead) made in accordance with a preferred embodiment of the present invention. Large volume ink drops 21 and small volume ink drops 23 are ejected from printhead 17 substantially along ejection path X in a stream. A droplet deflector 40 applies a force (shown generally at 46) to ink drops 21 and 23 as ink drops 21 and 23 travel along path X. Force 46 interacts with ink drops 21 and 23 along path X, causing the ink droplets 21 and 23 to alter course. As ink drops 21 have different volumes and masses from ink drops 23, force 46 causes small droplets 23 to separate from large droplets 21 with small droplets 23 diverging from path X along small droplet path S. While large droplets 21 are affected to a lesser extent by force 46 and travel along path K.

Upper plenum 120 is disposed opposite the end of droplet deflector 40 and promotes laminar gas flow while protecting the droplet stream moving along path X from external air disturbances. An ink recovery conduit 70 contains a ink guttering structure 60 whose purpose is to intercept the path K of large drops 21, while allowing small ink drops traveling along small droplet path S to continue on to the recording media W carried by print drum 80. Ink recovery conduit 70 communicates with ink recovery reservoir 90 to facilitate recovery of non-printed ink droplets by an ink return line 100 for subsequent reuse. Ink recovery reservoir contains open-cell sponge or foam 130 which prevents ink sloshing in applications where the printhead 17 is rapidly scanned. A vacuum conduit 110, coupled to a negative pressure source can communicate with ink recovery reservoir 90 to create a negative pressure in ink recovery conduit 70 improving ink droplet separation and ink droplet removal. The gas flow rate in ink recovery conduit 70, however, is chosen so as to not significantly perturb small droplet path S. Additionally, a gas recirculation plenum 50 diverts a small fraction of the gas flow crossing ink droplet path X to provide a source for the gas which is drawn into ink recovery conduit 70. In a preferred implementation, the gas pressure in droplet deflector 40 and in ink recovery conduit 70 are adjusted in combination with the design of ink recovery conduit 70 and recirculation plenum 50 so that the gas pressure in the print head assembly near ink guttering structure 60 is positive with respect to the ambient air pressure near print drum 80. Environmental dust and paper fibers are thusly discouraged from approaching and adhering to ink guttering structure 60 and are additionally excluded from entering ink recovery conduit 70.

In operation, a recording media W is transported in a direction transverse to axis x by print drum 80 in a known manner. Transport of recording media W is coordinated with movement of print mechanism 10 and/or movement of printhead 17. This can be accomplished using controller 13 in a known manner. Print media W can be of any type and in any form. For example, the print media can be in the form of a web or a sheet. Additionally, print media W can be composed from a wide variety of materials including paper, vinyl, cloth, other large fibrous materials, etc. Any mechanism can be used for moving the printhead assembly 10 relative to the media, such as a conventional raster scan mechanism, etc.

Printhead 17 can be formed using a silicon substrate 6, etc. Printhead 17 can be of any size and components thereof can have various relative dimensions. Heater 3, electrical contact pad 11, and conductor 18 can be formed and patterned through vapor deposition and lithography techniques, etc. Heater 3 can include heating elements of any shape and type, such as resistive heaters, radiation heaters, convection heaters, chemical reaction heaters (endothermic or exothermic), etc. The invention can be controlled in any appropriate manner. As such, controller 13 can be of any type, including a microprocessor-based device having a predetermined program, etc.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. An inkjet printer comprising:
a print head having a nozzle from which a stream of ink droplets is emitted; and
a mechanism adapted to adjust a characteristic of the emitted ink droplets such that selected pairs of droplets emitted from the nozzle coalesce to form larger droplets while other ones of droplets emitted from the nozzle do not coalesce.

2. An ink jet printer as set forth in claim 1, further comprising a droplet deflector which imposes a force on the droplets at an angle greater than zero with respect to the stream of ink droplets, said droplet deflector being adapted to interact with said stream of ink droplets to thereby separate non-coalesced ink droplets from coalesced ink droplets.

3. An inkjet printer as set forth in claim 2 wherein the droplet deflector uses a flow of gas to impose the force on the droplets.

4. An inkjet printer as set forth in claim 1, wherein the selected pairs of droplets emitted from the nozzle that coalesce to form larger droplets are spaced apart less that are the other ones of droplets that are emitted from the nozzle and which do not coalesce.

5. An ink jet printer as set forth in claim 1, wherein one of the droplets making up a selected pair of droplets that coalesce is smaller than the other droplet making up that selected pair.

6. An inkjet printer as set forth in claim 1, wherein the mechanism includes a heater at the nozzle and a device to energize the heater with a pulse for each droplet to be emitted, an interval between pulses being adjustable such that a predetermined interval between pulses produces a pair of droplets that do not coalesce, and less than said predetermined interval between pulses produces a pair of droplets that coalesce.
